(19) United States
(12) Patent Application Publication
(10) Pub. No.: US 2007/0222733 A1
(43) Pub. Date: Sep. 27, 2007

(54) LCD DEVICE CAPALE OF DRIVING IN AN INTERLACED SCAN MODE OR IN A PROGRESSIVE SCAN MODE AND RELATED DRIVING METHOD THEREOF

(76) Inventors: Shiue-Tien Ju, Hsin-Chu Hsien (TW); Wen-Pin Chou, Hsin-Chu Hsien (TW); Jen-Hao Hsuen, Tai-Chung City (TW)

Correspondence Address: NORTH AMERICA INTELLECTUAL PROPERTY CORPORATION, P.O. BOX 506, MERRIFIELD, VA, 22116, US

(21) Appl. No.: 11/379,802

(22) Filed: Apr. 24, 2006

(30) Foreign Application Priority Data
Mar. 23, 2006 (TW) 095110130

(51) Int. Cl. G09G 3/36

(52) U.S. Cl. 345/98

(57) ABSTRACT

An LCD device includes a LCD panel, a driver circuit coupled to the LCD panel for driving the LCD panel, a memory coupled to the driver circuit, a micro control unit for outputting image data to the memory, a selecting device for selecting an operation mode that the driver circuit drives the LCD panel from an interlaced scan mode and a progressive scan mode, and a control device for controlling the driver circuit to drive the LCD panel in the interlaced scan mode or in the progressive scan mode according to the operation mode selected by the selecting device.

### BACKGROUND OF THE INVENTION

1. Field of the Invention

The present invention relates to a liquid crystal display (LCD) and a related method for driving the LCD, and more specifically, to a liquid crystal display (LCD) and a related method for driving the LCD capable of switching its operation mode between an interlaced scan mode and a progressive scan mode.

2. Description of the Prior Art

The progress of science and technology has led to small, effective, and portable intelligent information products becoming a part of our lives. Display devices play an important role because all intelligent information products, such as mobile phones, personal digital assistants (PDAs), or notebooks, need display devices to be a communication interface. Because the liquid crystal display (LCD) panel is characterized by light weight, low power consumption, and low radiation, heavy cathode ray tube terminals (CRTs) are gradually superseded by LCDs. As the light beams pass the liquid crystal molecular layer, the polarization and the refraction of the light beams vary according to the orientation of the liquid crystal molecules. Accordingly, the light transmittance of the liquid crystal display panel can be controlled through altering the orientation of the liquid crystal molecules, and therefore, the liquid crystal display device can represent red, blue, and green light with different gray levels to display images.

Please refer to FIG. 1, which is a block diagram of a LCD 10 of the prior art. The LCD 10 has a LCD panel 12, a driver circuit 14 coupled to the LCD panel 12 for driving the LCD panel 12, a memory 16 coupled to the driver circuit 14 for storing data of patterns, and a micro control unit (MCU) 18 for outputting the data of patterns to the memory 16. The memory 16 could be a static random access memory (SRAM). The driver circuit 14 comprises a segment electrode driver 20 coupled to the memory 16 and a common electrode driver 22. The operations of the LCD panel 12 of the LCD 10 are controlled by SEG signals, which are generated by the segment electrode driver 20, and COM signals, which are generated by the common electrode driver 22. The common electrode driver 22 drives one row of the pixels every scan period, and the segment electrode driver 20 outputs corresponding image signals according to the data of patterns received from the memory 16. When the SEG signals and the COM signals are at correct voltage levels, liquid crystals of corresponding pixels of the LCD panel 12 are driven to rotate to change the color of the corresponding pixels.

In general, the LCD 10 has to use the MCU 18 to change the data stored in the memory 16 to set up the images of the LCD panel 12. Please refer to FIG. 2, which is a comparison diagram of the data stored in the memory 16 and the image of the LCD panel 12. The data “0” or “1” stored in the memory 16 presents the voltage level of the SEG signal generated by the segment electrode driver 20, and the voltage gap between the COM signal and the SEG signal determine the brightness of corresponding pixels. When the data stored in the memory 16 is changed, the waveform of the SEG signal is changed correspondingly. Therefore, if the frequency of data changing (e.g. between “0” and “1)” of the memory 16 is increased, the waveform of the SEG signal will also change in a higher frequency, and power consumption of the driver circuit 14 is raised. For example, if the patterns of two adjacent rows of pixels shown in the LCD 10 have a great difference, for example bar patterns or checker patterns, power consumption of the driver circuit 14 is greater than that when displaying ordinary patterns. Please refer to FIG. 3, which is a timing diagram of COM signals and SEG signals for driving the LCD panel 12 in a progressive scan mode according to the prior art. Because the LCD panel 12 operates in the progressive scan mode, the sequence of the common electrode driver 22 for scanning the scan lines to drive the LCD panel is COM0→COM1→COM2→COM3. As shown in FIG. 3, when the common electrode driver 22 switches the scanning line from COM0 to COM1, because the data stored in the memory 16 is switched from “1” to “0”, the voltage levels of signals SEG0, SEG1, SEG2, and SEG3 are switched from high to low. Similarly, when the common electrode driver 22 switches the scanning line from COM1 to COM2, because the data stored in the memory 16 is switched from “0” to “1”, the voltage levels of signals SEG0, SEG1, SEG2, and SEG3 are switched from low to high. In addition, when the common electrode driver 22 switches the scanning line from COM2 to COM3, because the data stored in the memory 16 is switched from “1” to “0”, the voltage levels of signals SEG0, SEG1, SEG2, and SEG3 are switched from high to low again. Therefore, during scanning the four rows of pixels, each SEG signal has to be switched between low and high three times, which causes the power consumption of the driver circuit 14 to increase.

### SUMMARY OF THE INVENTION

The present invention discloses a liquid crystal display (LCD). The LCD comprises a LCD panel, a driver circuit coupled to the LCD panel for driving the LCD panel, a memory coupled to the driver circuit, a micro control unit (MCU) for outputting data of patterns to the memory, a selecting device for selecting an operation mode that the driver circuit uses to drive the LCD panel from an interlaced scan mode and a progressive scan mode according to the data of the patterns, and a control device for controlling the driver circuit to drive the LCD panel in the interlaced scan mode or in the progressive scan mode according to the operation mode selected by the selecting device.

The present invention also discloses a LCD driver. The LCD driver comprises a driver circuit coupled to the LCD panel for driving the LCD panel, a memory coupled to the driver circuit for storing data of patterns received from a micro control unit (MCU), a selecting device for selecting an operation mode that the driver circuit uses to drive the LCD panel from an interlaced scan mode and a progressive scan mode according to the data of the patterns, and a control device for controlling the driver circuit to drive the LCD panel in the interlaced scan mode or in the progressive scan mode according to the operation mode selected by the selecting device.

The present invention further discloses a method for driving a LCD. The method comprising (a) a micro control unit (MCU) of the LCD generating data of patterns, (b) determining whether the patterns conform to a specific pattern, (c) selecting an operation mode of a LCD panel of the LCD from an interlaced scan mode and a progressive scan mode according to a result of the determination in step (b); and (d) driving the LCD panel in the interlaced scan mode or in the progressive scan mode according to the operation mode selected in step (c).

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a LCD of the prior art.

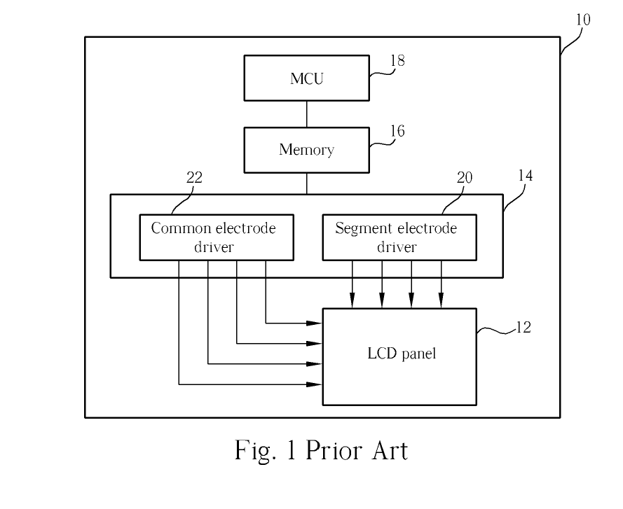

FIG. 2 is a comparison diagram of the data stored in the memory and the image of the LCD panel shown in FIG. 1.

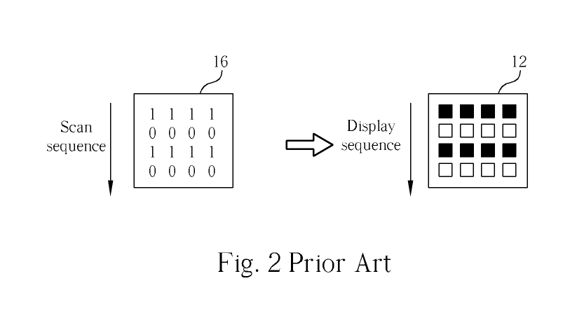

FIG. 3 is a timing diagram of COM signals and SEG signals for driving the LCD panel in a progressive scan mode according to the prior art.

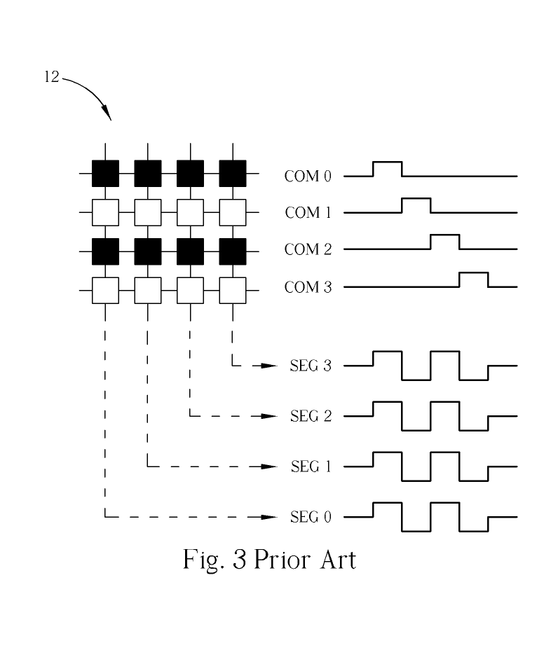

FIG. 4 is a block diagram of a LCD according to the present invention.

FIG. 5 is a flow chart to illustrate how the selecting device selects the operation mode of the LCD panel shown in FIG. 4.

FIG. 6 is a comparison diagram of the data of a bar pattern stored in the memory and the image of the LCD panel shown in FIG. 4.

FIG. 7 is a comparison diagram of the data of a checker pattern stored in the memory and the image of the LCD panel shown in FIG. 4.

FIG. 8 is a timing diagram of COM signals and SEG signals for driving the LCD panel shown in FIG. 4 in the interlaced scan mode according to the present invention.

FIG. 9 is a flow chart to illustrate how the selecting device shown in FIG. 4 selects the operation mode of the LCD panel in the second embodiment of the present invention.

FIG. 10 is a comparison diagram of the data of a bar pattern stored in the memory and the image of the LCD panel shown in FIG. 4.

FIG. 11 is a timing diagram of COM signals and SEG signals for driving the LCD panel shown in FIG. 4 of the second embodiment in the progressive scan mode.

### DETAILED DESCRIPTION

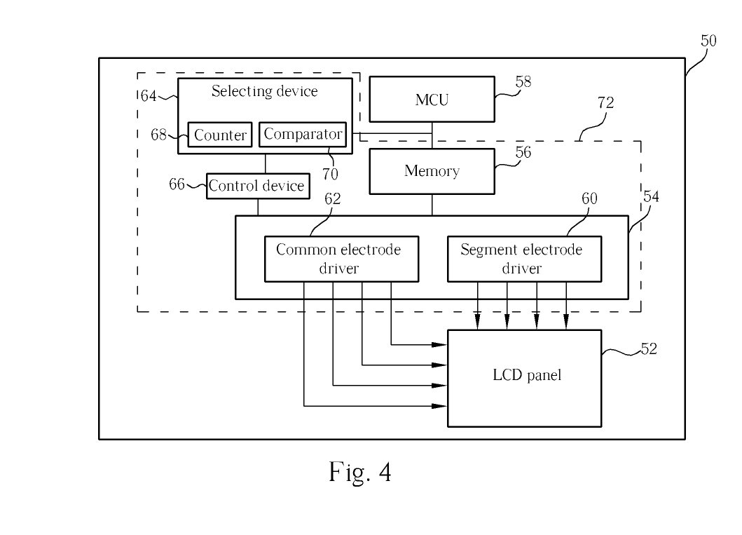

Please refer to FIG. 4, which is a block diagram of a LCD 50 according to the present invention. The LCD 50 comprises a LCD panel 52, a driver circuit 54 coupled to the LCD panel 52 for driving the LCD panel 52, a memory 56 coupled to the driver circuit 54 for storing data of patterns, and a micro control unit (MCU) 58 for outputting the data of patterns to the memory 56. In this embodiment, the memory 56 is a static random access memory (SRAM). The driver circuit 54 comprises a segment electrode driver 60 coupled to the memory 56 and a common electrode driver 62. The operations of the LCD panel 52 of the LCD 50 are controlled by SEG signals, which are generated by the segment electrode driver 60, and COM signals, which are generated by the common electrode driver 62. The common electrode driver 62 drives one row of the pixels every scan period, and the segment electrode driver 60 outputs corresponding image signals according to the data of patterns received from the memory 56. When the SEG signal and the COM signal are at correct voltage level, liquid crystal of corresponding pixel of the LCD panel 52 is driven to rotate to change the color of the corresponding pixel.

The LCD 50 further comprises a selecting device 64 for selecting an operation mode that the driver circuit 54 uses to drive the LCD panel 52 from an interlaced scan mode and a progressive scan mode according to the data of the patterns received from the MCU 58, and a control device 66 for controlling the driver circuit 54 to drive the LCD panel 52 in the interlaced scan mode or in the progressive scan mode according to the operation mode selected by the selecting device 64. The selecting device 64 and the control device 66 can be accomplished in a hardware form, a firmware form, or a software form. The selecting device 64 comprises a counter 68 for counting a number of the patterns from the MCU 58 conforming to the specific pattern, and a comparator 70 for determining whether the number counted by the counter 68 is larger than a predetermined number. When the number counted by the counter 68 is larger than the predetermined number, the selecting device 64 selects the interlaced scan mode as the operation mode that the driver circuit 54 uses to drive the LCD panel 52. In addition, the driver circuit 54, the memory 56, the selecting device 64, and the control device 66 can be integrated into a LCD driver.

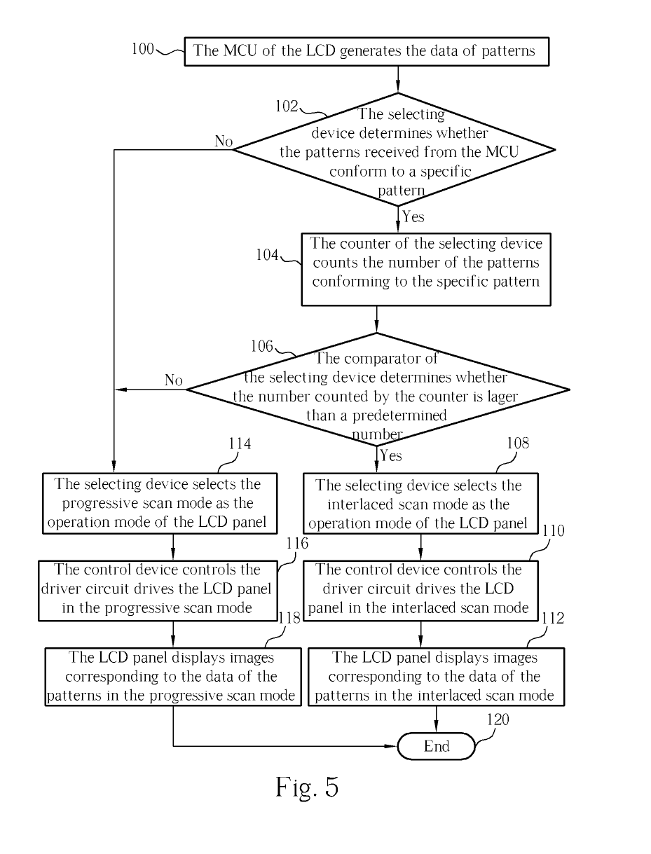

Please refer to FIG. 5, which is a flow chart to illustrate how the selecting device 64 selects the operation mode of the LCD panel 52. The method for selecting the operation mode of the LCD panel 52 according to the present invention comprises following steps:

Step 100: The MCU 58 of the LCD 50 generates the data of patterns;

Step 102: The selecting device 64 determines whether the patterns received from the MCU 58 conform to a specific pattern, if so execute step 104, if not execute step 114;

Step 104: The counter 68 of the selecting device 64 counts the number of the patterns conforming to the specific pattern;

Step 106: The comparator 70 of the selecting device 64 determines whether the number counted by the counter 68 is larger than a predetermined number, if so execute step 108, if not execute step 114;

Step 108: The selecting device 64 selects the interlaced scan mode as the operation mode of the LCD panel 52;

Step 110: The control device 66 controls the driver circuit 54 drives the LCD panel 52 in the interlaced scan mode;

Step 112: The LCD panel 52 displays images corresponding to the data of the patterns in the interlaced scan mode;

Step 114: The selecting device 64 selects the progressive scan mode as the operation mode of the LCD panel 52;

Step 116: The control device 66 controls the driver circuit 54 drives the LCD panel 52 in the progressive scan mode;

Step 118: The LCD panel 52 displays images corresponding to the data of the patterns in the progressive scan mode; and

Step 120: End.

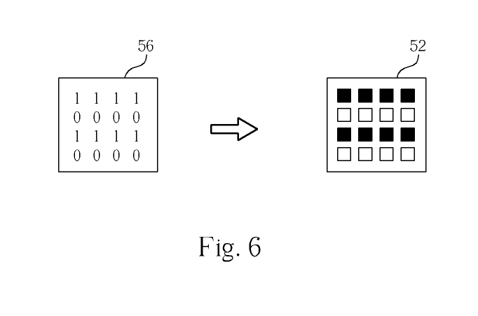

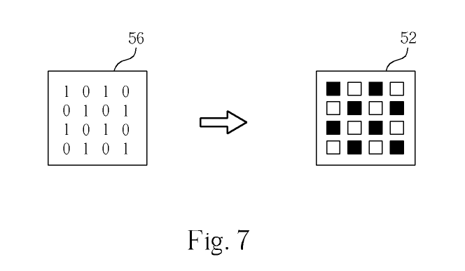

More detail descriptions are explained as follows. The MCU 58 generates the data of the patterns and transmits the data of the patterns to the memory 56 to store the data of the patterns in the memory 56. The selecting device 64 determines whether the patterns conform to the specific pattern, where the specific pattern may be a bar pattern or a checker pattern that there are a great difference between two adjacent rows of pixels. Please refer to FIGS. 6-7. FIG. 6 is a comparison diagram of the data of a bar pattern stored in the memory 56 and the image of the LCD panel 52. FIG. 7 is a comparison diagram of the data of a checker pattern stored in the memory 56 and the image of the LCD panel 52. The data “0” or “1” stored in the memory 56 presents the voltage level of the SEG signals generated by the segment electrode driver 60 and determines whether corresponding pixels are light or dark. When the data stored in the memory 56 is changed, the waveform of the SEG signal is changed correspondingly. Therefore, if the frequency of data changing of the memory 56 is increased, the waveform of the SEG signal becomes undulated violently and power consumption of the driver circuit 54 is increased. As shown in FIGS. 6-7, because the data stored in the memory 56 is changed violently when the pattern is a bar pattern or a checker pattern, the power consumption of the driver circuit 54 is greater than when displaying ordinary patterns.

When the selecting device 64 determines the patterns from the MCU 58 do not conform to the specific pattern, it means that the power consumption of the driver circuit 54 is not greater than a predetermined level. Therefore, the selecting device 64 selects the progressive scan mode as the operation mode of the LCD panel 52 and outputs corresponding selection signal to the control device 66. After receiving the selection signal from the selecting device 64, the control device 54 drives the LCD panel 52 in the progressive scan mode. In addition, when the selecting devices 64 determines the patterns from the MCU 58 conform to the specific pattern and the number counted by the counter 68 is not larger than the predetermined number, it means that the power consumption of the driver circuit 54 is not greater than the predetermined level. Therefore, the selecting device 64 selects the progressive scan mode as the operation mode of the LCD panel 52 and outputs corresponding selection signal to the control device 66. After receiving the selection signal from the selecting device 64, the control device 54 drives the LCD panel 52 in the progressive scan mode. However, if the number counted by the counter 68 is larger than the predetermined number, it means that the power consumption of the driver circuit 54 is greater than the predetermined level. The selecting device 64 selects the interlaced scan mode as the operation mode of the LCD panel 52 and outputs corresponding selection signal to the control device 66. After receiving the selection signal from the selecting device 64, the control device 54 drives the LCD panel 52 in the interlaced scan mode so that the power consumption of the driver circuit 54 is reduced.

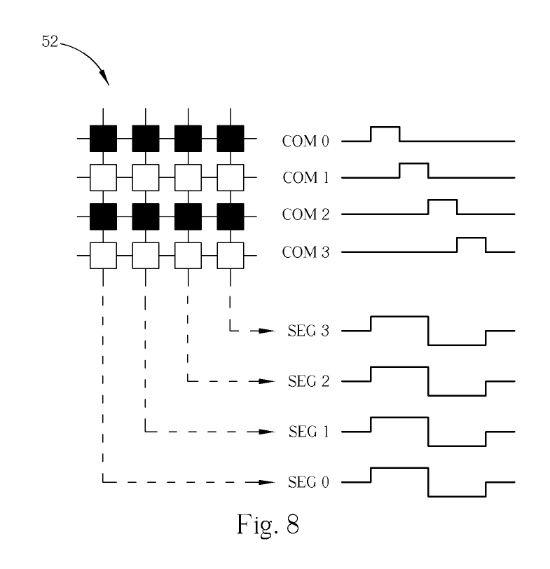

Please refer to FIG. 8, which is a timing diagram of COM signals and SEG signals for driving the LCD panel 52 in the interlaced scan mode according to the present invention. Because the LCD panel 52 is driven in the interlaced scan mode, the data stored in the memory 56 is rearranged. For example, the data of odd rows of pixels is arranged prior to the data of even rows of pixels so that the segment electrode driver 60 sequentially reads the data from the memory 56 to generate corresponding SEG signals for the interlaced scan mode. In another case, the data stored in the memory 56 is not rearranged, and the segment electrode driver 60 first reads the data of the odd rows of pixels and then reads the data of the even rows of pixels to generate corresponding SEG signals for the interlaced scan mode. The sequence of the common electrode driver 62 for scanning the scan lines to drive the LCD panel 52 is COM0→COM2→COM1→COM3. As shown in FIG. 8, when the common electrode driver 62 switches the scanning line from COM0 to COM2, because the data stored in the memory 56 is still “1”, the voltage levels of signals SEG0, SEG1, SEG2, and SEG3 are maintained at high. When the common electrode driver 62 switches the scanning line from COM2 to COM1, because the data stored in the memory 56 is switched from “1” to “0”, the voltage levels of signals SEG0, SEG1, SEG2, and SEG3 are switched from high to low. In addition, when the common electrode driver 22 switches the scanning line from COM1 to COM3, because the data stored in the memory 56 is still “0”, the voltage levels of signals SEG0, SEG1, SEG2, and SEG3 are maintained at low. Therefore, during scanning the four rows of pixels, each SEG signal has to be switched between low and high once. In contrast to the prior art that voltage levels of the SEG signals switches three times of displaying four rows of pixels every scan period in the progressive scan mode, the present invention switches the operation mode to the interlaced scan mode to change the sequence for scanning of the common electrode driver 62 to reduce the frequency of switching for SEG signals under the same memory 56 and not to influence the quality of display. Therefore, the voltage level change of the SEG signals is decreased and the power consumption of the driver circuit 54 is reduced.

In addition, the present invention also provides a method for driving a LCD panel 52 in the progressive scan mode when the patterns conform to a specific pattern and driving a LCD panel 52 in the interlaced scan mode when the patterns do not conform to the specific pattern. For example, when the patterns include a double bar pattern, which has two adjacent rows of data with “1” and two adjacent rows of data with “0”, the LCD panel 52 is driven in the progressive scan mode. In this case, the selecting device 64 selects the progressive scan mode as the operation mode of the LCD panel 52 when the number counted by the counter 70 is greater than the predetermined number.

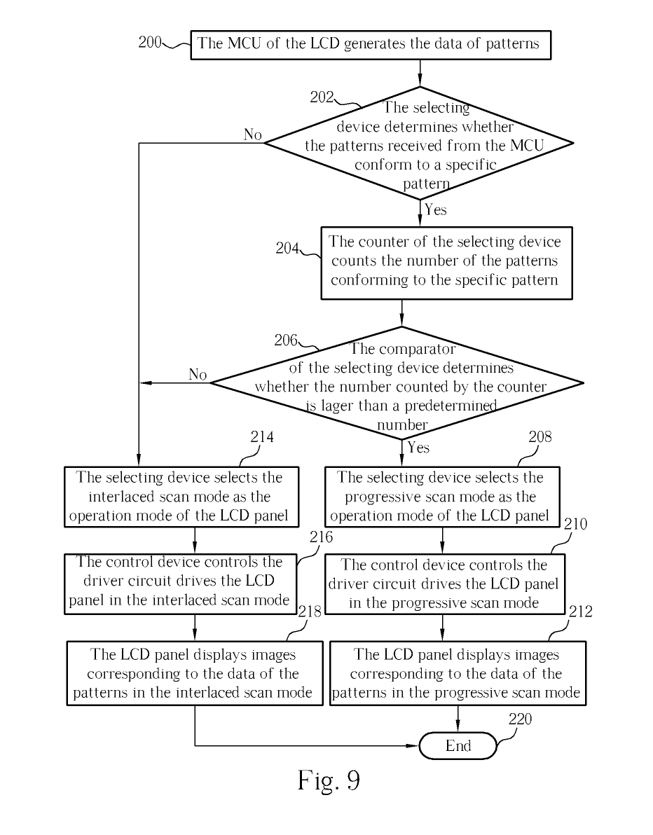

Please refer to FIG. 9, which is a flow chart to illustrate how the selecting device 64 selects the operation mode of the LCD panel 52 in the second embodiment of the present invention. The second method for selecting the operation mode of the LCD panel 52 according to the present invention comprises following steps:

Step 200: The MCU 58 of the LCD 50 generates the data of patterns;

Step 202: The selecting device 64 determines whether the patterns received from the MCU 58 conform to a specific pattern, if so execute step 204, if not execute step 214;

Step 204: The counter 68 of the selecting device 64 counts the number of the patterns conforming to the specific pattern;

Step 206: The comparator 70 of the selecting device 64 determines whether the number counted by the counter 68 is larger than a predetermined number, if so execute step 208, if not execute step 214;

Step 208: The selecting device 64 selects the progressive scan mode as the operation mode of the LCD panel 52;

Step 210: The control device 66 controls the driver circuit 54 drives the LCD panel 52 in the progressive scan mode;

Step 212: The LCD panel 52 displays images corresponding to the data of the patterns in the progressive scan mode;

Step 214: The selecting device 64 selects the interlaced scan mode as the operation mode of the LCD panel 52;

Step 216: The control device 66 controls the driver circuit 54 drives the LCD panel 52 in the interlaced scan mode;

Step 218: The LCD panel 52 displays images corresponding to the data of the patterns in the interlaced scan mode; and

Step 220: End.

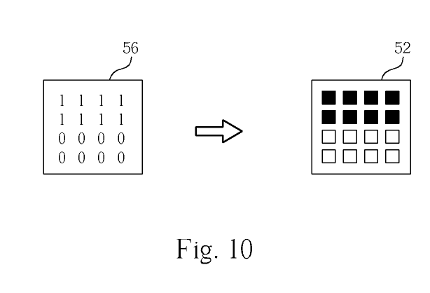

Different from the first embodiment, the specific pattern in the second embodiment is a double bar pattern that has two adjacent rows of data with “1” and two adjacent rows of data with “0”. Please refer to FIG. 10, which is a comparison diagram of the data of a bar pattern stored in the memory 56 and the image of the LCD panel 52. The data “0” or “1” stored in the memory 56 presents the voltage level of the SEG signals generated by the segment electrode driver 60 and determines whether corresponding pixels are light or dark. When the frequency of data changing of the memory 56 is lower, the waveform of the SEG signal becomes undulated smoothly and power consumption of the driver circuit 54 is reduced. As shown in FIG. 10, because the data stored in the memory 56 is changed once when the scan line switches from the second line to the third line, the power consumption of the driver circuit 54 when the LCD panel 52 is driven in the progressive scan mode is lower than that when the LCD panel 52 is driven in the interlaced scan mode. Moreover, when the LCD panel 52 is driven in the progressive scan mode, the power consumption of the driver circuit 54 when the LCD panel displays a double bar pattern is less than that when the LCD panel displays a bar pattern or a checker pattern.

When the selecting device 64 determines the patterns from the MCU 58 do not conform to the specific pattern, it means that the power consumption of the driver circuit 54 is not greater than a predetermined level. Therefore, the selecting device 64 selects the interlaced scan mode as the operation mode of the LCD panel 52 and outputs corresponding selection signal to the control device 66. After receiving the selection signal from the selecting device 64, the control device 54 drives the LCD panel 52 in the interlaced scan mode. In addition, when the selecting devices 64 determines the patterns from the MCU 58 conform to the specific pattern and the number counted by the counter 68 is not larger than the predetermined number, it means that the power consumption of the driver circuit 54 is not greater than the predetermined level. Therefore, the selecting device 64 selects the interlaced scan mode as the operation mode of the LCD panel 52 and outputs corresponding selection signal to the control device 66. After receiving the selection signal from the selecting device 64, the control device 54 drives the LCD panel 52 in the progressive scan mode. However, if the number counted by the counter 68 is larger than the predetermined number, it means that the power consumption of the driver circuit 54 is greater than the predetermined level. The selecting device 64 selects the progressive scan mode as the operation mode of the LCD panel 52 and outputs corresponding selection signal to the control device 66. After receiving the selection signal from the selecting device 64, the control device 54 drives the LCD panel 52 in the progressive scan mode so that the power consumption of the driver circuit 54 is reduced.

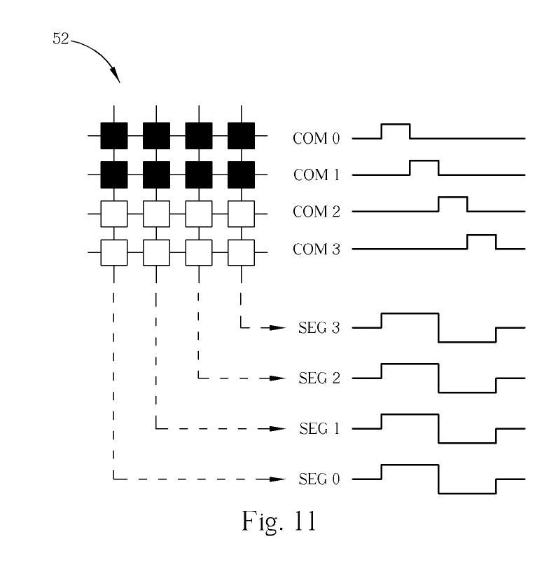

Please refer to FIG. 11, which is a timing diagram of COM signals and SEG signals for driving the LCD panel 52 of the second embodiment in the progressive scan mode. Because the LCD panel 52 is driven in the progressive scan mode, the sequence of the common electrode driver 62 for scanning the scan lines to drive the LCD panel 52 is COM0→COM1→COM2→COM3. As shown in FIG. 11, when the common electrode driver 62 switches the scanning line from COM0 to COM1, because the data stored in the memory 56 is still “1”, the voltage levels of signals SEG0, SEG1, SEG2, and SEG3 are maintained at high. When the common electrode driver 62 switches the scanning line from COM1 to COM2, because the data stored in the memory 56 is switched from “1” to “0”, the voltage levels of signals SEG0, SEG1, SEG2, and SEG3 are switched from high to low. In addition, when the common electrode driver 22 switches the scanning line from COM2 to COM3, because the data stored in the memory 56 is still “0”, the voltage levels of signals SEG0, SEG1, SEG2, and SEG3 are maintained at low. Therefore, during scanning the four rows of pixels, each SEG signal has to be switched between low and high once. In contrast to the prior art that voltage levels of the SEG signals switches three times every scan period in the interlaced scan mode, the present invention switches the operation mode to the progressive scan mode to reduce the frequency of switching for SEG signals. Therefore, the power consumption of the driver circuit 54 is reduced.

In contrast to the prior art LCD and related driving method, the present invention provides a LCD, a LCD driver circuit and a driving method for the LCD that can switch the operation mode between an interlaced scan mode and a progressive scan mode according to data of the patterns used for refreshing images of the LCD. When the patters include a specific pattern, the operation mode can be switched to a proper mode, i.e. the interlaced scan mode or the progressive scan mode, to decrease the switching frequency of the SEG signals, reduce the power consumption of the driver circuit, and maintain the image quality of the LCD.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A liquid crystal display (LCD) comprising:
a LCD panel;
a driver circuit coupled to the LCD panel for driving the LCD panel;
a memory coupled to the driver circuit;
a micro control unit (MCU) for outputting data of patterns to the memory;
a selecting device for selecting an operation mode that the driver circuit uses to drive the LCD panel from an interlaced scan mode and a progressive scan mode according to the data of the patterns; and
a control device for controlling the driver circuit to drive the LCD panel in the interlaced scan mode or in the progressive scan mode according to the operation mode selected by the selecting device.

2. The LCD of claim 1 wherein the driver circuit comprises:
a segment electrode driver coupled to the memory; and
a common electrode driver coupled to the selecting device.

3. The LCD of claim 1 wherein the memory is a static random access memory (SRAM).

4. The LCD of claim 1 wherein the selecting device selects the interlaced scan mode as the operation mode of the LCD panel when the patterns conform to a specific pattern.

5. The LCD of claim 4 wherein the specific pattern is an interlaced bar pattern.

6. The LCD of claim 4 wherein the specific pattern is a checker pattern.

7. The LCD of claim 4 wherein the selecting device comprises:
a counter for counting a number of the patterns conforming to the specific pattern; and
a comparator for determining whether the number counted by the counter is larger than a predetermined number;
wherein the selecting device selects the interlaced scan mode as the operation mode of the LCD panel when the number counted by the counter is larger than the predetermined number.

8. The LCD of claim 1 wherein the selecting device selects the progressive scan mode as the operation mode of the LCD panel when the patterns conform to a specific pattern.

9. The LCD of claim 8 wherein the specific pattern is a double bar pattern.

10. The LCD of claim 8 wherein the selecting device comprises:
a counter for counting a number of the patterns conforming to the specific pattern; and
a comparator for determining whether the number counted by the counter is larger than a predetermined number;
wherein the selecting device selects the progressive scan mode as the operation mode of the LCD panel when the number counted by the counter is larger than the predetermined number.

11. A Liquid Crystal Display (LCD) driver comprising:
a driver circuit coupled to the LCD panel for driving the LCD panel;
a memory coupled to the driver circuit for storing data of patterns received from a micro control unit (MCU);
a selecting device for selecting an operation mode that the driver circuit uses to drive the LCD panel from an interlaced scan mode and a progressive scan mode according to the data of the patterns; and
a control device for controlling the driver circuit to drive the LCD panel in the interlaced scan mode or in the progressive scan mode according to the operation mode selected by the selecting device.

12. The LCD driver of claim 11 wherein the driver circuit comprises:
a segment electrode driver coupled to the memory; and
a common electrode driver coupled to the selecting device.

13. The LCD driver of claim 11 wherein the memory is a static random access memory (SRAM).

14. The LCD driver of claim 11 wherein the selecting device selects the interlaced scan mode as the operation mode of the LCD panel when the patterns conform to a specific pattern.

15. The LCD driver of claim 14 wherein the specific pattern is an interlaced bar pattern.

16. The LCD driver of claim 14 wherein the specific pattern is a checker pattern.

17. The LCD driver of claim 14 wherein the selecting device comprises:
a counter for counting a number of the patterns conforming to the specific pattern; and
a comparator for determining whether the number counted by the counter is larger than a predetermined number;
wherein the selecting device selects the interlaced scan mode as the operation mode of the LCD panel when the number counted by the counter is larger than the predetermined number.

18. The LCD driver of claim 11 wherein the selecting device selects the progressive scan mode as the operation mode of the LCD panel when the patterns conform to a specific pattern.

19. The LCD driver of claim 18 wherein the specific pattern is a double bar pattern.

20. The LCD driver of claim 18 wherein the selecting device comprises:
a counter for counting a number of the patterns conforming to the specific pattern; and
a comparator for determining whether the number counted by the counter is larger than a predetermined number;
wherein the selecting device selects the progressive scan mode as the operation mode of the LCD panel when the number counted by the counter is larger than the predetermined number.

21. A method for driving a LCD, the method comprising following steps:
(a) a micro control unit (MCU) of the LCD generating data of patterns;
(b) determining whether the patterns conform to a specific pattern;
(c) selecting an operation mode of a LCD panel of the LCD from an interlaced scan mode and a progressive scan mode according to a result of the determination in step (b); and
(d) driving the LCD panel in the interlaced scan mode or in the progressive scan mode according to the operation mode selected in step (c).

22. The method of claim 21 wherein step (c) comprises selecting the operation mode of the LCD panel of the LCD from the interlaced scan mode and the progressive scan mode when the patterns conform to a specific pattern.

23. The method of claim 22 wherein step (c) further comprises:
(c1) counting a number of the patterns conforming to the specific pattern;
(c2) determining whether the number counted in (c1) is larger than a predetermined number; and
(c3) selecting the operation mode of the LCD panel from the interlaced scan mode and the progressive scan mode according to a result of determination of step (c2).

24. The method of claim 23 wherein step (c3) comprises selecting the interlaced scan mode as the operation mode of the LCD panel when the number counted in step (c1) is larger than the predetermined number.

25. The method of claim 24 wherein the specific pattern is an interlaced bar pattern.

26. The method of claim 24 wherein the specific pattern is a checker pattern.

27. The method of claim 23 wherein step (c3) comprises selecting the progressive scan mode as the operation mode of the LCD panel when the number counted in step (c1) is larger than the predetermined number.

28. The method of claim 27 wherein the specific pattern is a double bar pattern.
